(19) United States
(12) Patent Application Publication
(10) Pub. No.: US 2006/0176249 A1
(43) Pub. Date: Aug. 10, 2006

(54) Setting up a pixel in a plasma display

(75) Inventors: Robert G. Marcotte, New Paltz, NY (US); Norifusa Isobe, New Paltz, NY (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Matsushita Electric Industrial Co., LTD.

(21) Appl. No.: 11/053,511

(22) Filed: Feb. 8, 2005

(51) Int. Cl. G09G 3/28

(52) U.S. Cl. 345/63

(57) ABSTRACT

There is provided a method that includes generating a first waveform for a first electrode of a pixel of a plasma display, and generating a second waveform for a second electrode of the pixel. The first waveform includes a first setup waveform and a first sustain waveform, and the second waveform includes a second setup waveform and a second sustain waveform. The first and second setup waveforms are generated during a setup period for setting a wall charge of the pixel, and the first and second sustain waveforms are generated during a sustain period for sustaining a discharge of a gas in a region of the pixel. The first setup waveform attains a voltage that is more positive than a maximum positive voltage of the first sustain waveform, and the second setup waveform attains a voltage that is more negative than a maximum negative voltage of the second sustain waveform. There is also provided a plasma display and a controller that employ the method.

### BACKGROUND OF THE INVENTION

1. Field of the Invention

The present disclosure relates to plasma displays, and more particularly, to a technique of generating voltages for electrodes of a pixel in a plasma display in a manner that maintains stability of a discharge of gas in a region of the pixel.

2. Description of the Related Art

A plasma display includes a front plate and a rear plate sealed together and having a space therebetween filled with a dischargeable gas. The front plate includes horizontal rows of electrodes, each row being configured with a sustain electrode in parallel with a scan electrode. The scan electrodes and the sustain electrodes are covered by a dielectric layer and a magnesium oxide (MgO) layer. The rear plate supports vertical barrier ribs and plural vertical column conductors. In a color display, individual column electrodes are covered with red, green, or blue (RGB) phosphors. A pixel is defined as a region proximate to an intersection of (i) a scan electrode and a sustain electrode, and (ii) three column conductors, one for each color. In a monochrome display, a single column conductor is used for each pixel, and a phosphor combination is used to achieve the monochromatic color. Visible light is emitted by the phosphors following UV excitation, produced when a voltage of a sufficient magnitude is applied across a volume of the gas to cause the gas to discharge. When the gas discharges, the atoms of the gas are excited, when the atoms relax, the atoms emit UV photons, which, in turn, excite the phosphor.

In operation, the plasma display partitions a frame of time into sub-fields, each of which produces a portion of the light required to achieve a proper intensity of each pixel. Each sub-field is partitioned into a setup period, an addressing period and a sustain period. The sustain period is further partitioned into a plurality of sustain cycles.

The setup period resets any ON pixels to an OFF state, and provides priming to the gas and to the MgO surface to allow for subsequent addressing. In the setup period, each interior surface of the pixel's electrodes is placed at a voltage very close to a firing voltage of the gas.

During the addressing period, the sustain electrodes are driven with a common potential, while scan electrodes are driven such that a row of pixels is selected so that pixels in that row can be addressed via an addressing discharge triggered by an application of a data voltage on a vertical column electrode. Thus, during the addressing period, each row is sequentially addressed to place desired pixels in the ON state.

During the sustain period, a common sustain pulse is applied to all scan electrodes to repetitively generate plasma discharges at each pixel addressed during the addressing period. That is, if a pixel is turned ON during the address period, the pixel is repetitively discharged in the sustain period to produce a desired brightness.

The dimension of space between adjacent electrodes, and the overall width of the electrodes, influence the pixel's discharge capacitance, which in turn influences discharge power and therefore brightness. Each discharge yields a certain level of brightness, and therefore a number of discharges in a predetermined period of time is chosen to meet an overall brightness requirement for an image being displayed.

For the setup operation to precisely control the interior surface voltage of the electrodes within the pixel, ramping waveforms are employed. The slope of the ramp allows the gas breakdown to be exceeded causing weak positive resistance discharges to reduce the voltage to just below the gas breakdown voltage. In the three-electrode topology of the pixel, it is desirable to setup of all three electrodes uniformly.

### SUMMARY OF THE INVENTION

There is provided a method that includes generating a first waveform for a first electrode of a pixel of a plasma display, and generating a second waveform for a second electrode of the pixel. The first waveform includes a first setup waveform and a first sustain waveform, and the second waveform includes a second setup waveform and a second sustain waveform. The first and second setup waveforms are generated during a setup period for setting a wall charge of the pixel, and the first and second sustain waveforms are generated during a sustain period for sustaining a discharge of a gas in a region of the pixel. The first setup waveform attains a voltage that is more positive than a maximum positive voltage of the first sustain waveform, and the second setup waveform attains a voltage that is more negative than a maximum negative voltage of the second sustain waveform. There is also provided a plasma display and a controller that employ the method.

### BRIEF DESCRIPTION OF THE DRAWINGS

FIG. 1 is a schematic of a portion of a plasma display.

FIGS. 2-5 are graphs of waveforms for voltages presented to electrodes of a pixel for the plasma display of FIG. 1.

### DESCRIPTION OF THE INVENTION

A pixel in a plasma display has inherently symmetrical properties as its front electrodes typically have equal widths and so, are symmetrical about a sustain gap separating the electrodes. A gap between the front electrodes and a back electrode is constant, therefore, a voltage relationship of each front electrode to the back electrode is inherently symmetrical. A technique for driving the pixel, as described herein, takes advantage of the symmetrical nature of the electrodes to provide stable gas discharges during setup operations for the pixel.

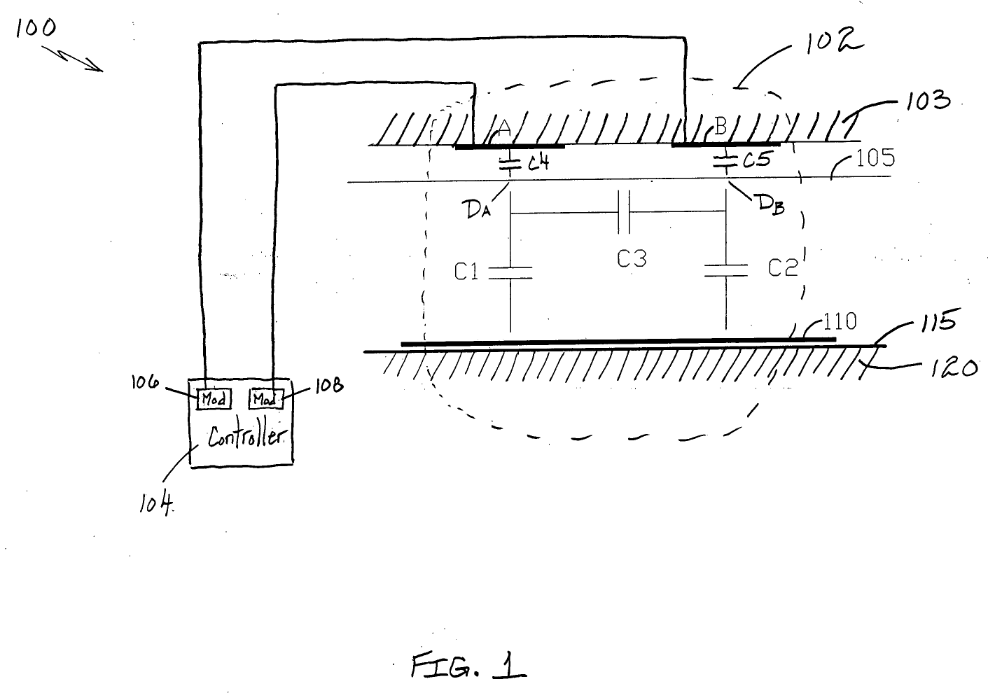

FIG. 1 is a schematic of a portion of a plasma display 100. Plasma display 100 includes a front substrate 103, an electrode A, an electrode B, a dielectric layer 105, a phosphor surface 110, a data electrode 115, a back substrate 120, and a controller 104. Electrodes A and B are disposed on front substrate 103. Dielectric layer 105 covers electrodes A and B. A MgO layer (not shown) is deposited on dielectric layer 105. Data electrode 115 is disposed on back substrate 120. Phosphor surface 110 covers data electrode 115. A space between dielectric layer 105 and phosphor surface 110 is filled with a dischargeable gas mixture typically comprising xenon and neon gasses. A pixel 102 is defined as a region proximate to an intersection of electrode A, electrode B and data electrode 115.

The MgO layer covering dielectric layer 105 aids in a discharge of the gas by providing secondary electron emission, necessary for the gas discharge to avalanche. Additionally, MgO will emit electrons at a slow rate for a long period of time following discharge activity. This emission is an aid to addressing a plasma display.

Pixel 102 includes several capacitances represented in FIG. 1 as capacitances C1, C2, C3, C4 and C5. These capacitances are not physical components, per se, but rather, capacitative characteristics that occur as a result of the geometry of pixel 102. Capacitances C1, C2 and C3 become small resistances during a strong gas discharge.

Capacitances C1 and C2 represent capacitances between the surface of dielectric layer 105 and phosphor surface 110. Capacitance C4 represents a capacitance between electrode A and the surface of dielectric layer 105. Capacitance C5 represents a capacitance between electrode B and the surface of dielectric layer 105. Capacitances C4 and C5 are of much larger values than capacitances C1 and C2, respectively, and so, for purposes of the present discussion, voltage drops across capacitances C4 and C5 are considered as being negligible. Thus, for the present discussion, a voltage on electrode A is regarded as being the same as a voltage at the top of C1, and a voltage on electrode B is regarded as being the same as a voltage at the top of capacitance C2. Capacitance C3 represents a capacitance within the gas between electrode A and electrode B.

The gas has a breakdown voltage. If a voltage across a volume of the gas exceeds the breakdown voltage, the gas discharges. Depending on the magnitude of the voltage across the gas, the discharge will be either a weak positive resistive discharge or a strong negative resistance discharge.

The weak positive resistance discharge occurs when the voltage applied across the volume of gas is only slightly greater than the breakdown voltage. During the weak positive resistance discharge, the gas retains a resistive characteristic, and the discharge persists only until the voltage is reduced to marginally less than the breakdown voltage. Thus, when the discharge ends, the voltage across the gas is marginally less than the breakdown voltage.

The strong negative resistance discharge occurs when the voltage applied across the volume of gas is more than slightly greater than the gas discharge voltage. During the strong negative resistance discharge, the resistance of the gas becomes very low, and all voltage across the gas is dissipated. Thus, a strong negative resistance discharge is an avalanching discharge.

Because the gas is dischargeable, the maximum voltage obtainable across capacitances C1, C2 and C3 is the breakdown voltage of the gas. For example, if the voltage across capacitance C1 exceeds the breakdown voltage by a small amount, a positive resistance discharge occurs, reducing the voltage across capacitance C1 to, or marginally below, the breakdown voltage. Similarly, exceeding the breakdown voltage by a small amount across either of capacitances C2 or C3 results in a positive resistance discharge that reduces the voltage across capacitance C2 or C3, respectively, to, or marginally below, the breakdown voltage. However, if the voltage across any of capacitances C1, C2 or C3 is exceeded by a sufficient amount, a strong negative resistance discharge occurs that reduces the voltage to zero across all three capacitances.

Electrode A and electrode B may be driven to create a weak positive resistance discharge across capacitance C3 while creating very little discharge activity across capacitances C1 and C2. This is accomplished by applying voltage waveforms to electrodes A and B that are approximately equal in peak-to-peak voltage but opposite in polarity. Dielectric layer 105 has a dielectric area DA adjacent to electrode A, and a dielectric area DB adjacent to electrode B. The weak positive resistance discharge across capacitance C3 sets a charge on dielectric area DA and dielectric area DB such that the voltage across capacitance C3 is slightly below the breakdown voltage of the gas. Similarly, a slight discharge activity is required across capacitances C1 and C2 to reference the dielectric areas DA and DB to phosphor surface 110. That is, with data electrode 115 at a fixed voltage, electrode A may be driven to create a weak positive resistance discharge across capacitances C1 and C3, and electrode B may be driven to create a weak positive resistance discharge across capacitances C2 and C3. With voltages across each of capacitances C1, C2 and C3 being close to the gas breakdown voltage, an addressing voltage applied to data electrode 115 during an addressing operation can be minimized. The minimum peak-to-peak voltage to create a weak positive resistance discharge across capacitance C3 is typically slightly greater than twice the breakdown voltage across capacitances C1 and C2. This is of particular importance for a case in which electrode A is used for row selection, since the strong address discharge is triggered by a weak discharge between the phosphor surface 110 and a selected row. Once the address discharge is triggered, a strong negative resistance discharge depletes the voltage across all three capacitances C1, C2 and C3.

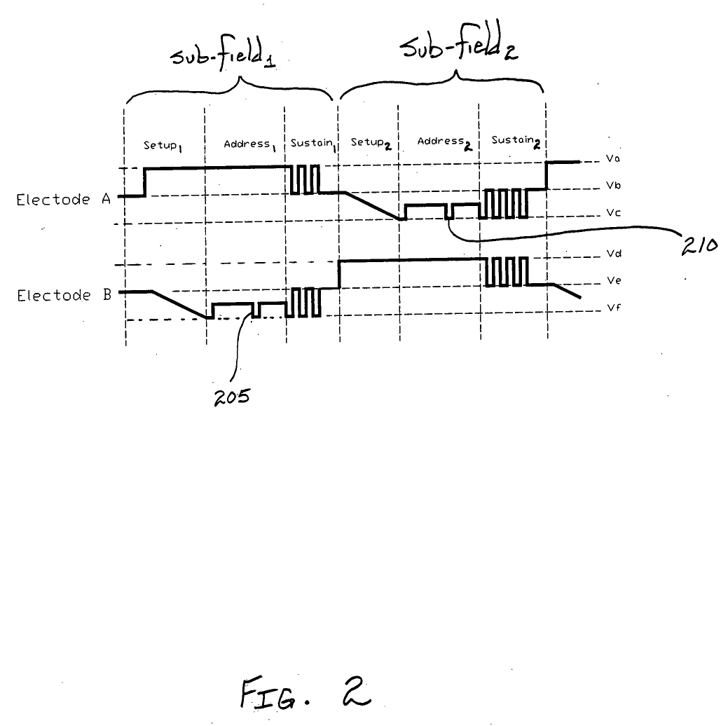

Controller 104 includes a module 106 and a module 108. Module 106 generates voltage waveforms for electrode A, and module 108 generates voltage waveforms for electrode B. The operation of controller 104 is described below in greater detail in association with FIGS. 2-5, each of which is a graph of a set of waveforms generated by controller 104 for electrodes A and B.

The term “module” is used herein to denote a functional operation that may be embodied either as a stand-alone component or as an integrated configuration of a plurality of sub-ordinate components. Controller 104, and modules 106 and 108, can be implemented in any of hardware, firmware, software, or a combination thereof.

FIG. 2 is a graph of waveforms that include two sub-fields, namely sub-field₁ and sub-field₂. Each of sub-field₁ and sub-field₂ includes a setup period, an addressing period, and a sustain period. For sub-field₁ these periods are designated setup₁, address₁, and sustain₁. For sub-field₂ these periods are designated setup₂, address₂, and sustain₂.

The waveform for electrode A attains voltages Va, Vb and Vc. The waveform for electrode B attains voltages Vd, Ve and Vf. Voltages Va, Vb and Vc are referenced to a point on phosphor surface 110 at the bottom of capacitance C1, and voltages Vd, Ve and Vf are referenced to a point on phosphor surface 110 at the bottom of capacitance C2. Voltages Va, Vb and Vc are approximately equal to voltages Vd, Ve and Vf, respectively. Consequently, the peak-to-peak voltages applied to electrode A and to electrode B are about equal to each other. That is Va-Vc is about equal to Vd-Vf. Furthermore, each of the peak-to-peak voltages, i.e., Va-Vc and Vd-Vf, are about equal to twice the breakdown voltage of the gas.

During setup₁, controller 104 generates a ramp having a negative slope for electrode B while generating a higher level for electrode A. The ramp traverses from voltage Ve to a maximum negative voltage of Vf. The level generated for electrode A is at voltage Va. This configuration of waveforms produces a weak positive resistance discharge between electrode A and electrode B such that at the end of the ramp, the voltage across capacitance C3 within the gas volume is at, or near, the breakdown voltage of the gas. Additionally, the maximum positive voltage on electrode A, Va, is chosen so that the voltage across capacitance C1 will be close to or slightly over the breakdown voltage of the gas across capacitance C1. Similarly, the maximum negative voltage applied to electrode B, Vf, is chosen so that the voltage across capacitance C2 will be close to or slightly over the breakdown voltage of the gas across capacitance C2. Thus at the end of setup1, if voltage on electrode A is increased positively form Va, a discharge activity will occur across capacitances C1 and C3 with a current flow sourced from electrode A. Similarly, if voltage on electrode B is increased negatively from Vf, then a discharge activity will occur across capacitances C2 and C3 with a current flowing into electrode B. Thus Va is the upper bound for electrode A to prevent discharge activity, and Vf is the lower bound for electrode B to prevent discharge activity.

During address₁, controller 104 maintains voltage Va for electrode A, and generates a row select pulse 205 for electrode B. If a data voltage (not shown) is applied to data electrode 115 coincident with row select pulse 205, that is, if pixel 102 is addressed, then a strong negative resistance discharge forms across capacitance C2, which extends across capacitance C3, resulting in a depletion of the voltages across capacitances C1, C2 and C3, and a charging of capacitances C4 and C5. With capacitances C1, C2 and C3 short-circuited by the gas discharge, capacitances C4 and C5 form a capacitive divider between voltages Va and Vf, achieving a level close to voltages Vb and Ve respectively. Thus, during address₁, controller 104 generates an addressing waveform for electrode B to enable an initial gas discharge of pixel 102 during sub-field₁.

During sustain₁, controller 104 generates a plurality of sustain pulses for each of electrodes A and B. The sustain pulses for electrode A achieve a maximum positive voltage of Va and a maximum negative voltage of Vb. The sustain pulses for electrode B achieve a maximum positive voltage of Ve and a maximum negative voltage of Vf. If pixel 102 was addressed during address₁, the sustain pulses on electrodes A and B during sustain₁ will cause the gas in the region of pixel 102 to be repetitively discharged.

Because an application, across the gas, of a voltage of greater than the breakdown voltage causes a gas discharge, the magnitudes of the sustain pulses are effectively limited by the breakdown voltage. Since setup₁ established a positive boundary on electrode A, the sustain pulses applied to electrode A during sustain₁ are limited to a voltage nearly equal to, or below, voltage level Va to prevent an erroneous discharging of capacitance C1. During the sustain period, OFF pixels, which were not addressed, need to remain off. This is guaranteed if the bounds established during the setup operation are not exceeded. Similarly, electrode B's low level during sustain₁ is limited to level Vf to prevent an erroneous discharging of capacitance C2.

During setup₂, controller 104 generates a ramp having a negative slope for electrode A while generating a higher level for electrode B. The ramp traverses from voltage Vb to a maximum negative voltage of Vc. The level generated for electrode B is at voltage Vd. This configuration of waveforms produces a weak positive resistance discharge between electrode A and electrode B such that at the end of the ramp, the voltage across capacitance C3 within the gas volume is at, or near, the breakdown voltage of the gas. Thus, electrode A is set to a negative boundary level, while electrode B is set to a positive boundary level. Operation of setup₂ is similar to setup₁, except that electrode A, rather than being setup with an upper bound, is being setup with a lower bound of voltage Vc, and electrode B, rather than being setup with a lower bound, is being setting up with a positive bound of voltage Vd. Thus, after execution of setup₁ and setup₂, the operating range of both electrode A and electrode B are defined, and phosphor surface 110 covering data electrode 115 is referenced to both electrode A and electrode B. The configuration of waveforms in setup₂ also prepares pixel 102 for address₂. More specifically, if pixel 102 was ON during sustain₁, the waveforms in setup₂ return pixels 102 to the OFF state, and if pixel 102 was not addressed during address₁, and therefore not ON during sustain₁, then pixel 102 will be setup by the falling ramp on electrode A to the opposite boundary compared to setup₁.

During address₂, controller 104 generates a row select pulse 210 for electrode A. If a data voltage (not shown) is applied to data electrode 115 coincident with row select pulse 210, that is, if pixel 102 is addressed, then a strong negative resistance discharge forms across C1 which extends across capacitance C3 resulting in a depletion of the voltages across capacitances C1, C2 and C3, and a charging of capacitances C4 and C5. Thus, during address₂, controller 104 generates an addressing waveform for electrode B to enable an initial gas discharge of pixel 102 during sub-field₂.

During sustain₂, controller 104 generates a plurality of sustain pulses for each of electrodes A and B. The sustain pulses for electrode A achieve a maximum positive voltage of Vb and a maximum negative voltage of Vc. The sustain pulses for electrode B achieve a maximum positive voltage of Vd and a maximum negative voltage of Ve. If pixel 102 was addressed during address₁, the sustain pulses on electrodes A and B during sustain₁ will cause the gas in the region of pixel 102 to be repetitively discharged.

Note that the number of sustain pulses in sustain₂ is not necessarily equal to the number of sustain pulses in sustain₁. This is because different levels of illumination may be desired for different sub-fields, and the number of gas discharges is directly proportional to the desired level of illumination. For example, depending on the dynamics of an image being displayed, some sub-fields will be required to provide a relatively high level of illumination, and thus, a relatively high number of gas discharges, while other sub-field will be required to provide a relatively low level of illumination, and thus, a relatively low number of gas discharges.

Although not shown in FIG. 2, the waveforms for electrodes A and B include additional sub-fields. The waveforms in setup periods for odd numbered sub-fields, e.g., a sub-field₃ (not shown), are the same as the waveforms shown for setup₁, and the waveforms in setup periods for even numbered sub-fields, e.g., a sub-field₄ (not shown), are the same as the waveforms shown for setup₂. Thus, in a sequence of consecutive sub-fields, the waveforms of setup₁ alternate with the waveforms of setup₂, providing for weak positive resistance discharges in each of the setup periods, which prime the MgO layer (not shown) covering dielectric surface 105, enhancing the addressability of pixel 102.

For electrode A, the setup waveform of setup₁ attains a voltage that is more positive than a maximum positive voltage of the sustain waveform of sustain₂. That is, Va is more positive than Vb. For electrode B, the setup waveform of setup₁ attains a voltage that is more negative than a maximum negative voltage of the sustain waveform of sustain₂. That is, Vf is more negative than Ve. Furthermore, since the waveforms of setup₁ alternate with the waveforms of setup₂, for electrode A, the setup waveform of setup₃ (not shown) attains a voltage that is more positive than a maximum positive voltage of the sustain waveform of sustain₂, and for electrode B, the setup waveform of setup₃ attains a voltage that is more negative than a maximum negative voltage of the sustain waveform of sustain₂. Note that for this comparison of waveforms of sustain₂ and setup₃, sustain₂ occurs prior to setup₃.

The setting up of electrodes A and B, as described above, has several advantages over prior art setup techniques. Firstly, The act of switching between a positive boundary and a negative boundary on both electrodes allows for better defined internal capacitance voltages, allowing for the application of lower peak voltages with reduced background brightness produced by the setup discharges. Lower peak voltages also reduce the voltage requirements of the panel's dielectric materials. Secondly, each falling ramp setup provides the MgO layer with a weak discharge during the falling ramp proceeding each addressing period, which improves address ability. Thirdly, the stability of the positive resistance ramp discharges is enhanced by encouraging sustain gap discharges, across C3, and discouraging plate gap discharges, across C1 and C2, as sustain gap discharges are more stable as both surfaces are covered my the MgO layer. The use of falling ramps for setup operations is advantageous as the phosphor surface covering the data electrodes acts as an anode during the application of the falling ramp. Common phosphor materials have a poor to negligible secondary electron emission characteristic, thus making the phosphor a poor cathode for a positive resistance discharge. However when the phosphor serves as an anode, there is less likelihood that a positive resistance discharge can over develop, go unstable, and avalanche. An avalanching setup discharge is undesirable because it results in a negative resistance discharge that, in turn, reduces the voltage across the gas to zero and effectively turns the pixel into the ON state regardless of addressing operations. Lastly, identical circuits and voltages are applied to each side, allowing for power supply simplification.

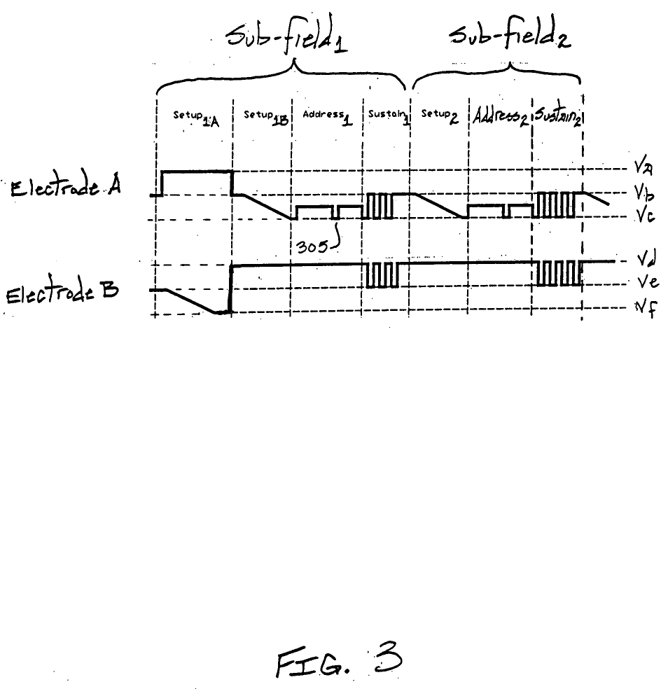

FIG. 3 is a graph of waveforms in which sub-field₁ includes two setup periods, an address period, and a sustain period, namely, setup_{1A}, setup_{1B}, address₁, and sustain₁, respectively. Sub-field₂ includes a setup period, an address period, and a sustain period, namely, setup₂, address₂, and sustain₂, respectively. As in FIG. 2, (i) the waveform for electrode A attains voltages Va, Vb and Vc, (ii) the waveform for electrode B attains voltages Vd, Ve and Vf, and (iii) voltages Va, Vb and Vc are approximately equal to voltages Vd, Ve and Vf, respectively.

During setup_{1A}, controller 104 generates voltage Va for electrode A, and generates a ramp having a negative slope for electrode B. The ramp traverses from voltage Ve to a maximum negative voltage Vf. Setup_{1A} occurs only once per frame, at the beginning of the frame, in subfield₁, to setup boundary levels for electrodes A and B. Here, electrode A is set to a positive boundary and electrode B is set to a negative reference boundary. By setting up positive and negative boundary levels, operation of pixel 102 is well defined since the negative slope on electrode B defines the minimum operating point for capacitance C2, ensuring that when operating at the positive boundary level, capacitance C2 is operated close to but below its breakdown voltage.

During setup_{1B}, controller 104 generates a ramp having a negative slope for electrode A, and generates voltage Vd for electrode B. The ramp traverses from voltage Vb to a maximum negative voltage Vc. This configuration of waveforms produces a weak positive resistance discharge between electrode A and electrode B such that at the end of the ramp, the voltage across capacitance C3 within the gas volume is at, or near, the breakdown voltage of the gas. Thus, pixel 102 is setup for address₂.

During address₁, controller 104 generates a row select pulse 305 for electrode A, and maintains voltage Vd for electrode B. If a data voltage (not shown) is applied to data electrode 115 coincident with row select pulse 305, that is, if pixel 102 is addressed, then a strong negative resistance discharge forms across C1, which extends across capacitance C3 resulting in a depletion of the voltages across capacitances C1, C2 and C3. As discharge current flows from electrode B to electrode A, capacitances C4 and C5 charge via a capacitor divider between electrode A and electrode B as capacitance C3 becomes a very low resistance during the discharge. The charge on capacitances C4 and C5 define the ON state for pixel 102. Note that in the ON state after the discharge, the interior voltage on each surface will be close to voltage Vb on electrode A and Ve on electrode B, thus Vb is close to or equal to Ve.

During sustain₁, controller 104 generates a plurality of sustain pulses for each of electrodes A and B. The sustain pulses for electrode A achieve a maximum positive voltage of Vb and a maximum negative voltage of Vc. The sustain pulses for electrode B achieve a maximum positive voltage of Vd and a maximum negative voltage of Ve. If pixel 102 was addressed during address₁, the charge on capacitances C4 and C5 will add to the voltages supplied by sustain pulses on electrodes A and B during sustain₁ thus causing the gas in the region of pixel 102 to be repetitively discharged.

In setup₂, address₂ and sustain₂, controller 104 generates the same waveforms as in setup_{1B}, address₁ and sustain₁, respectively. Setup_{1B} removes the charge from capacitances C4 and C5 of any ON pixels and restores the charge on capacitances C1, C2, and C3 in preparation for addressing. Furthermore, although not shown in FIG. 3, the waveforms for electrodes A and B include additional sub-fields. For each of the additional sub-fields, controller 104 generates the same waveforms as in setup_{1B}, address₁ and sustain₁ although the number of sustain pulses typically varies from one sustain period to another.

For electrode A, the setup waveform of setup_{1A} attains a voltage that is more positive than a maximum positive voltage of the sustain waveforms of sustain₁ and sustain₂. That is, Va is more positive than Vb. For electrode B, the setup waveform of setup_{1A} attains a voltage that is more negative than a maximum negative voltage of the sustain waveforms of sustain₁ and sustain₂. That is, Vf is more negative than Ve.

In FIG. 3, the peak-to-peak voltage applied to electrode A and the peak-to-peak voltage applied to electrode B are about equal to each other. That is Va-Vc is about equal to Vd-Vf. Additionally, the negative ramp on electrode B during setup_{1A}, biases electrode B such that when electrode B is driven to voltage Vd in setup_{1B}, the voltage across the gas between electrode B and data electrode 115 is near its maximum. Thus the peak-to-peak voltage applied to each of electrode A and electrode B will be close to twice the breakdown voltage of the gas across C1. Also, in setup_{1A} the application of voltage Va on electrode A biases electrode A such that when electrode A is driven to voltage Va, the voltage across the gas between electrode A and data electrode 115 is close to or slightly above the gas breakdown voltage across capacitance C1. For the waveforms of FIG. 3, since electrode A will be used for row selection, it is preferable to have the peak-to-peak voltage of electrode A, i.e., Va-Vc, to be greater than twice the breakdown voltage of the gas across capacitance C2 so that a weak positive resistance discharge will occur on the falling ramp occurring in setup_{1B}. The peak-to-peak voltages applied to electrodes A and B reference capacitances C1 and C2 to phosphor surface 110, and the coincidence of the negative ramp on electrode B, achieving electrode B's most negative voltage, and the application of the most positive voltage on electrode A, accurately sets boundary voltages for electrodes A and B while maintaining the reference to phosphor surface 110. Thus the setup discharges in setup_{1A} and setup_{1B} are more stable, and voltage Va may be reduced considerably, compared with not applying the negative ramp to electrode B, since the weak positive resistance discharge occurs predominately across capacitance C3.

The waveforms of FIG. 3 provide single sided addressing and the ability to perform a single full setup to prime the MgO layer (not shown) covering dielectric surface 105, while subsequent setup periods only return pixel 102 from the ON state to the OFF state, thus reducing background glow.

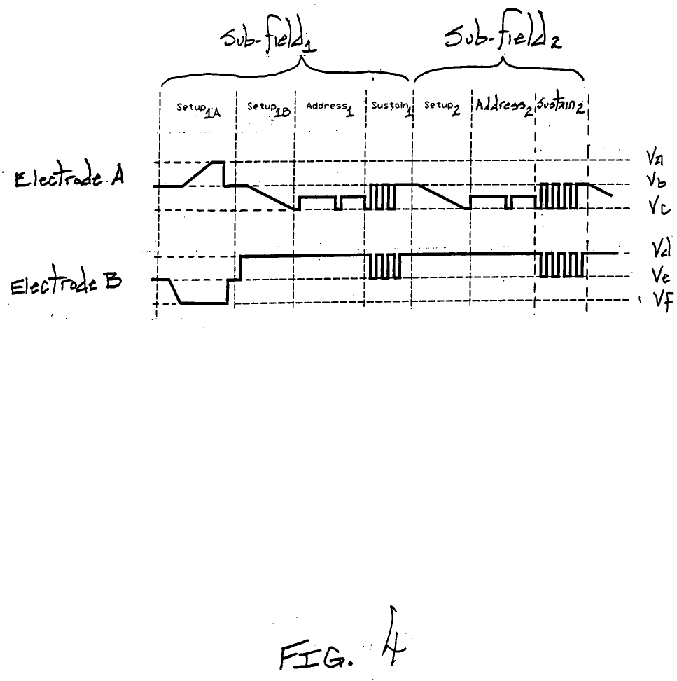

FIG. 4 shows waveforms similar to those of FIG. 3, except that in FIG. 4, in setup_{1A}, controller 104 generates a positive sloping ramp for electrode A, and a negative sloping ramp for electrode B. This configuration of waveforms is desirable when the peak-to-peak voltage is higher on electrode A than electrode B for the purpose of increasing discharge activity during the setup discharge. The increased discharge activity increases the excitation of the MgO material, which slowly decays during the frame time. In the case where many sub-fields do not include discharges, the increased emission of the MgO surface improves addressing in later sub-fields since electrode A will be used for the row selection during the addressing periods and thus benefits from the increased emission.

The ramps for electrodes A and B in FIG. 4, setup_{1A}, can be coincident in time or skewed in time from one another. Also, although the ramps are of opposite polarities, their slopes may be at either the same rate or different rates.

For electrode A, the setup waveform of setup_{1A} attains a voltage that is more positive than a maximum positive voltage of the sustain waveforms of sustain₁ and sustain₂. That is, Va is more positive than Vb. For electrode B, the setup waveform of setup_{1A} attains a voltage that is more negative than a maximum negative voltage of the sustain waveforms of sustain₁ and sustain₂. That is, Vf is more negative than Ve.

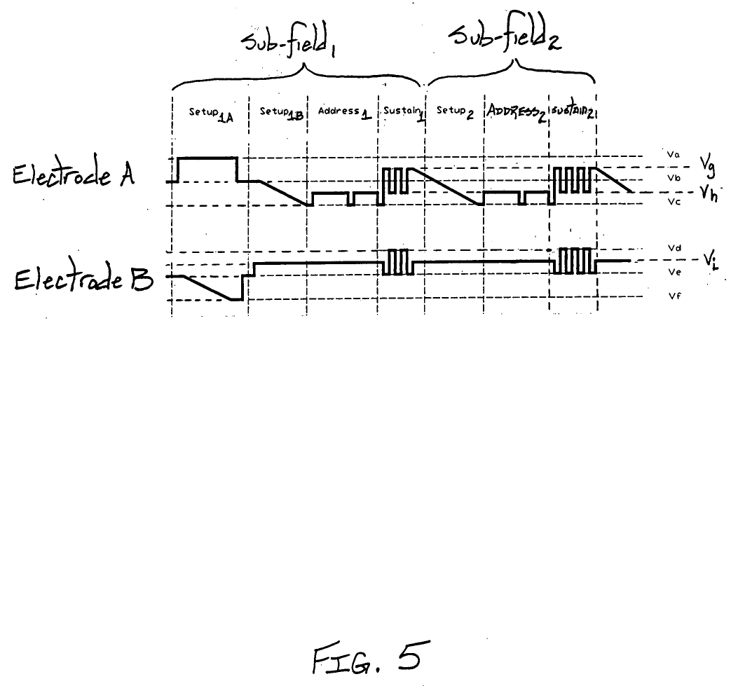

FIG. 5 shows waveforms similar to those of FIG. 3, except that (i) for electrode A, in the sustain periods, controller 104 generates sustain pulses having a maximum positive voltage Vg rather than voltage Vb, and a maximum negative voltage Vh rather than Vc, and (ii) for electrode B, in setup_{1B}, address₁, setup₂ and address₂, controller 104 generates a voltage Vi rather than voltage Vd. Vc<Vh<Vb<Vg<Va, and Ve<Vi<Vd. Thus, as compared to the waveforms of FIG. 3, the voltage on electrode B during the setup and address periods is reduced to weaken the discharge activity occurring as a result of the falling ramp on electrode A, which results from turning off an ON pixel from the previous sustain period.

For electrode A, the setup waveform of setup_{1A} attains a voltage that is more positive than a maximum positive voltage of the sustain waveforms of sustain₁ and sustain₂. That is, Va is more positive than Vg. For electrode B, the setup waveform of setup_{1A} attains a voltage that is more negative than a maximum negative voltage of the sustain waveforms of sustain₁ and sustain₂. That is, Vf is more negative than Ve.

As in the previous figures, the bounds of electrode A are Va and Vc, and the bounds of electrode B are Vd and Vf. However, electrode B reaches its upper bound during a sustain period. Electrode A's sustain pulses are operated within the bounds of Va and Vc, but are shifted above the negative bound Vc to a voltage Vh. This technique uses the established bounds to increase the applied voltage for the first sustain discharge, which can be slow or weak following a weak address discharge. Thus operating margins are improved.

In FIGS. 2-5, the relative duration of each of the periods in the sub-fields is not drawn to scale. Furthermore, in practice, the duration of the sustain periods, and the number of sustain pulses occurring in the sustain periods, will be much greater than that shown in FIGS. 2-5.

The techniques described herein are exemplary, and should not be construed as implying any particular limitation on the present invention. It should be understood that various alternatives, combinations and modifications could be devised by those skilled in the art. The present invention is intended to embrace all such alternatives, modifications and variances that fall within the scope of the appended claims.

What is claimed is:

1. A method comprising:
generating a first waveform for a first electrode of a pixel of a plasma display; and
generating a second waveform for a second electrode of said pixel,
wherein said first waveform includes a first setup waveform and a first sustain waveform,
wherein said second waveform includes a second setup waveform and a second sustain waveform,
wherein said first and second setup waveforms are generated during a setup period for setting a wall charge of said pixel,
wherein said first and second sustain waveforms are generated during a sustain period for sustaining a discharge of a gas in a region of said pixel,
wherein said first setup waveform attains a voltage that is more positive than a maximum positive voltage of said first sustain waveform, and
wherein said second setup waveform attains a voltage that is more negative than a maximum negative voltage of said second sustain waveform.

2. The method of claim 1, wherein said setup period occurs prior to said sustain period.

3. The method of claim 1, wherein said setup period and said sustain period are both parts of a single sub-field in a frame for controlling illumination intensity of said pixel.

4. The method of claim 1, wherein said sustain period occurs prior to said setup period.

5. The method of claim 1,
wherein said sustain period is a portion of a first sub-field in a frame for controlling illumination intensity of said pixel,
wherein said setup period is a portion of a second sub-field in said frame, and
wherein said second sub-field is consecutive to said first sub-field.

6. The method of claim 5,
wherein said second waveform further includes an addressing waveform to enable an initial discharge of said gas in said region of said pixel during said first sub-field; and
wherein said first waveform further includes an addressing waveform to enable an initial discharge of said gas in said region of said pixel during said second sub-field.

7. The method of claim 1, wherein said second setup waveform comprises a ramp having a negative slope.

8. The method of claim 1, wherein said first setup waveform comprises a ramp having a positive slope.

9. The method of claim 1,
wherein said first waveform has a first peak-to-peak voltage,
wherein said second waveform has a second peak-to-peak voltage, and
wherein said first and second peak-to-peak voltages are about equal to one another.

10. The method of claim 9,
wherein said gas has a breakdown voltage, and
wherein said first and second peak-to-peak voltages are about equal to twice said breakdown voltage.

11. A plasma display, comprising a controller that:
generates a first waveform for a first electrode of a pixel of said plasma display; and
generates a second waveform for a second electrode of said pixel,
wherein said first waveform includes a first setup waveform and a first sustain waveform,
wherein said second waveform includes a second setup waveform and a second sustain waveform,
wherein said first and second setup waveforms are generated during a setup period for setting a wall charge of said pixel,
wherein said first and second sustain waveforms are generated during a sustain period for sustaining a discharge of a gas in a region of said pixel,
wherein said first setup waveform attains a voltage that is more positive than a maximum positive voltage of said first sustain waveform, and
wherein said second setup waveform attains a voltage that is more negative than a maximum negative voltage of said second sustain waveform.

12. The plasma display of claim 11, wherein said setup period occurs prior to said sustain period.

13. The plasma display of claim 11, wherein said setup period and said sustain period are both parts of a single sub-field in a frame for controlling illumination intensity of said pixel.

14. The plasma display of claim 11, wherein said sustain period occurs prior to said setup period.

15. The plasma display of claim 11,
wherein said sustain period is a portion of a first sub-field in a frame for controlling illumination intensity of said pixel,
wherein said setup period is a portion of a second sub-field in said frame, and
wherein said second sub-field is consecutive to said first sub-field.

16. The plasma display of claim 15,
wherein said second waveform further includes an addressing waveform to enable an initial discharge of said gas in said region of said pixel during said first sub-field; and
wherein said first waveform further includes an addressing waveform to enable an initial discharge of said gas in said region of said pixel during said second sub-field.

17. The plasma display of claim 11, wherein said second setup waveform comprises a ramp having a negative slope.

18. The plasma display of claim 11, wherein said first setup waveform comprises a ramp having a positive slope.

19. The plasma display of claim 11,
wherein said first waveform has a first peak-to-peak voltage,
wherein said second waveform has a second peak-to-peak voltage, and
wherein said first and second peak-to-peak voltages are about equal to one another.

20. The plasma display of claim 19,
wherein said gas has a breakdown voltage, and
wherein said first and second peak-to-peak voltages are about equal to twice said breakdown voltage.

21. A controller, comprising:
a module that generates a first waveform for a first electrode of a pixel of a plasma display; and
a module that generates a second waveform for a second electrode of said pixel,
wherein said first waveform includes a first setup waveform and a first sustain waveform,
wherein said second waveform includes a second setup waveform and a second sustain waveform,
wherein said first and second setup waveforms are generated during a setup period for setting a wall charge of said pixel,
wherein said first and second sustain waveforms are generated during a sustain period for sustaining a discharge of a gas in a region of said pixel,
wherein said first setup waveform attains a voltage that is more positive than a maximum positive voltage of said first sustain waveform, and
wherein said second setup waveform attains a voltage that is more negative than a maximum negative voltage of said second sustain waveform.
